(19) United States
(12) Patent Application Publication
(10) Pub. No.: US 2004/0220859 A1
(43) Pub. Date: Nov. 4, 2004

(54) Self service checkout system

(75) Inventors: Edward J. McGunn, Posen, IL (US); James Ivey III, Posen, IL (US); Eduardo DeCastro Barcellos, Posen, IL (US); Wagner Bittencourt Oliveira, Posen, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Corporate Safe Specialists, Inc.

(21) Appl. No.: 10/428,365

(22) Filed: May 2, 2003

(51) Int. Cl. G06F 17/60

(52) U.S. Cl. 705/16

(57) ABSTRACT

A cash validation system is used with a point of sale system to provide a self service check out system. The cash validation system comprises a bill acceptor for receiving paper currency. A coin changer receives and dispenses coins. A control unit is operatively coupled to the bill acceptor and the coin changer for monitoring and commanding operation of the bill acceptor and the coin changer. An interface is operatively coupled between the control unit and the point of sale system for communicating information on received paper currency and coins to the point of sale system and receiving requests from the point of sale system to dispense change and response to the requests commanding operation of the coin changer.

### FIELD OF THE INVENTION

This invention relates to a cash validation system for use with a point of sale terminal to provide a self service check out system.

### BACKGROUND OF THE INVENTION

Throughout history, people have developed various systems to safeguard money. These systems are particularly useful in a retail environment. The use of credit cards and debit cards can lesson the transfer of currency. Nevertheless, cash payment remains an option so problems still remain.

Retail establishments use point of sale (POS) systems to conduct transactions. The POS system may include a keyboard for entering pricing information or a scanner for scanning UPC codes for items to be purchased. Once the purchased is totaled, then the customer gives the appropriate amount of cash to the cashier for placement in a cash drawer with any change to be given removed from the cash drawer and given to the customer. Due to mistake or theft, shrinkage in the available cash may occur.

While automation has streamlined the POS checkout process it is still necessary to employ a cashier to operate the POS system and handle the cash transaction. In fact, in some automated systems, such as fuel dispensing, the cashiers only involvement in the transaction might be to collect payment and make change. The expense of employing the cashier reduces profitability.

Accordingly, there is a need for a cash validation system for use with a point of sale terminal to provide a self service check out system.

### SUMMARY OF THE INVENTION

The present invention provides an interface between cash validation systems and a point of sale (POS) system. With this interface cash can be fed directly into the cash validation system by either a customer or a POS attendant. The cash is validated by the cash validation system which then communicates with the POS system via the interface and then the cash validation system returns correct change to the customer.

Broadly, in accordance of one aspect of the invention, there is disclosed a cash validation system for use with a point of sale system to provide a self service check out system. The cash validation system comprises a bill acceptor for receiving paper currency. A coin changer receives and dispenses coins. A control unit is operatively coupled to the bill acceptor and the coin changer for monitoring and commanding operation of the bill acceptor and the coin changer. An interface is operatively coupled between the control unit and the point of sale system for communicating information on received paper currency and coins to the point of sale system and receiving requests from the point of sale system to dispense change and in response to the requests commanding operation of the coin changer.

It is a feature of the invention that the point of sale system comprises a programmed processing system and the interface comprises a hardware control module implemented in the programmed processing system. The control unit is connected to the programmed processing system via a communication link. The communication link may comprise a serial interface.

It is another feature of the invention that the hardware control module comprises a coin changer interface routine for monitoring communications from the coin changer to receive device information and monitoring dispense events from the programmed processing system and in response to dispense events commanding operation of the coin changer.

It is another feature of the invention that the hardware control module comprises a bill acceptor interface routine for monitoring communications from the bill acceptor to receive device information.

In accordance with another aspect of the invention, the cash validation system uses a bill dispenser and acceptor for receiving and dispensing paper currency and the interface commands operation of the bill acceptor and dispenser and the coin changer.

There is disclosed in accordance with yet another aspect of the invention a cash validation system for use with a point of sale system to provide a self service check out system, comprising a safe having a door lock and door sensors. A bill dispenser and acceptor is mounted on the safe for receiving and dispensing paper currency. A coin changer is mounted on the safe for receiving and dispensing coins. A control unit is operatively coupled to the bill acceptor and dispenser and the coin changer for monitoring and commanding operation of the bill acceptor and dispenser and the coin changer. An interface is operatively coupled between the control unit and the point of sale system for communicating information on received paper currency on coins to the point of sale system and receiving requests from the point of sale system to dispense change and in response to the requests commanding operation of the bill acceptor and dispenser and the coin changer.

Further features and advantages of the invention will be readily apparent from the specification and from the drawings.

### BRIEF DESCRIPTION OF THE DRAWINGS

FIG. 1 is a block diagram of a cash validation system in accordance with the invention for use with a point of sale (POS) system to provide a self service check out system;

FIG. 2 is a flow diagram illustrating communication between a hardware control module of the cash validation system and the POS system;

FIG. 3 is a flow diagram illustrating a routine for operating a coin changer of the cash validation system of FIG. 1;

FIG. 4 is a flow diagram of a routine for operating a bill dispenser and acceptor of the cash validation system of FIG. 1;

FIG. 5 is a flow diagram illustrating a tube vending routine implemented by the cash validation system of FIG. 1.

### DETAILED DESCRIPTION OF THE INVENTION

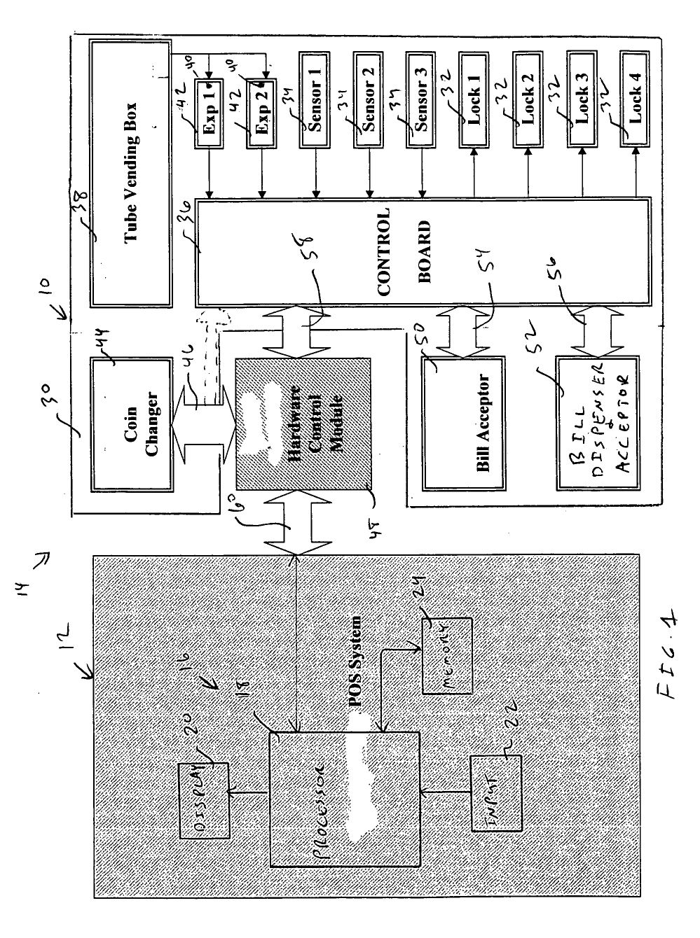

Referring initially to FIG. 1, a cash validation system 10 is provided for use with a point of sale (POS) terminal or system 12 to provide a self service check out system 14. With the self service checkout system 14 a customer can handle transactions directly or through an attendant without the need for a cash drawer. Instead, both paper currency and coins are provided to the cash validation system 10 and change in the form of coins and/or paper currency is provided directly from the cash validation system 10.

The POS system 12 may take any known form. The self service checkout system 14 can use virtually any type of POS system. The invention relates more particularly to providing an interface between a POS system and cash validation acceptance and dispensing devices, as described more specifically below.

In the illustrated embodiment of the invention, the exemplary POS system 12 comprises a programmed processing system 16. The programmed processing system 16 may be a conventional personal computer (PC) or the like including a processor 18. The processor 18 is connected to a display 20, inputs device 22 and a memory 24. The display 20 may be a conventional computer monitor. The input device 22 may include a keyboard and/or scanner or the like. Alternatively, the input display may be part of a touch screen monitor. The memory 24 may include RAM memory, ROM memory disk memory or any other type of memory for storing programs for operating the POS system 12 and for storing data related thereto. The data may include a database storing product and price information.

In use, the POS system 12 is operated by scanning goods to be purchased or entering information on the goods using a keypad. The methods and procedures for the up front operation of the POS transaction do not form part of the invention. Instead, the invention relates particularly to providing an interface with the cash validation system 10 to facilitate the cash transaction.

In the illustrated embodiment of the invention, the cash validation system 10 comprises a safe 30 having one or more doors selectively operated by plural locks 32. Door sensors 34 are provided for sensing if the doors are in an open or closed state. The electronic locks 32 and sensors 34 are electrically connected to a control board 36. The control board 36 comprises a control unit for sending commands to open the locks 32 and monitor status information from the sensors 34.

The safe 30 houses a tube vending box 38 for storing tubes or rolls of coins. The tube vending box 38 includes sensors 40 connected via expansion boards 42 to the control 36 for monitoring if tubes have been loaded or withdrawn from the tube vending box 38. A coin changer 44 is mounted to the outside of the safe and is adapted to both receive and dispense coins. The coin changer 44 may be of the type manufactured by Mars Electronics International. The coin changer 44 is operatively coupled via a serial interface 46 to either the control board 36 or a hardware control module 48 described below.

Also mounted to the outside of the safe are a bill acceptor 50 and/or a bill dispenser and acceptor 52. The bill acceptor may be of the type manufactured by Mars Electronics International or JCM American Corporation. The bill dispenser and acceptor 52 may be a bill recycler or the like as manufactured by JCM American Corporation. Both the bill acceptor 50 and the bill dispenser and acceptor 52 are operatively coupled to the control board 36 via respective serial interfaces 54 and 56.

As is apparent, any of the serial interfaces 46, 54 and 56 could be implemented using other forms of wired or wireless communication links, as will be apparent to those skilled in the art.

The cash dispensing system 10, including the safe 30, may be as generally described in pending application Ser. No. 09/982,348, filed Oct. 18, 2001, owned by the assignee of the present application, the specification of which is hereby incorporated by reference herein. Particularly, the referenced application describes both a method and an apparatus for monitoring a safe. The referenced application includes a control circuit for controlling operation of the safe. The operation of the control unit in the referenced application is implemented by the hardware control module 48 in combination with the control board 36. Particularly, the hardware control module 48 is functionally connected to the control board 36 via a serial interface 58.

In the illustrated embodiment of the invention, the hardware control module 48 is illustrated as being operatively coupled to the POS system 12 via a link 60. In fact, in the illustrated embodiment of the invention, the hardware control module 48 comprises a software module running in the POS processing system 16. Alternatively, the hardware control module 48 could be a physically separate hardware module coupled by, for example, a serial interface to the POS system 12. In either case, the hardware control module 48 comprises an interface operatively coupled between the control board 36 and the point of sale system 12. The hardware control module 48 receives information on deposited paper currency and coins from the devices 44, 50 or 52 and communicates such events to the point of sale system 12, and receives requests from the point of sale system 12 to dispense change and, in response to such requests, commanding operation of the bill dispenser and acceptor 52 and the coin changer 44 to dispense change.

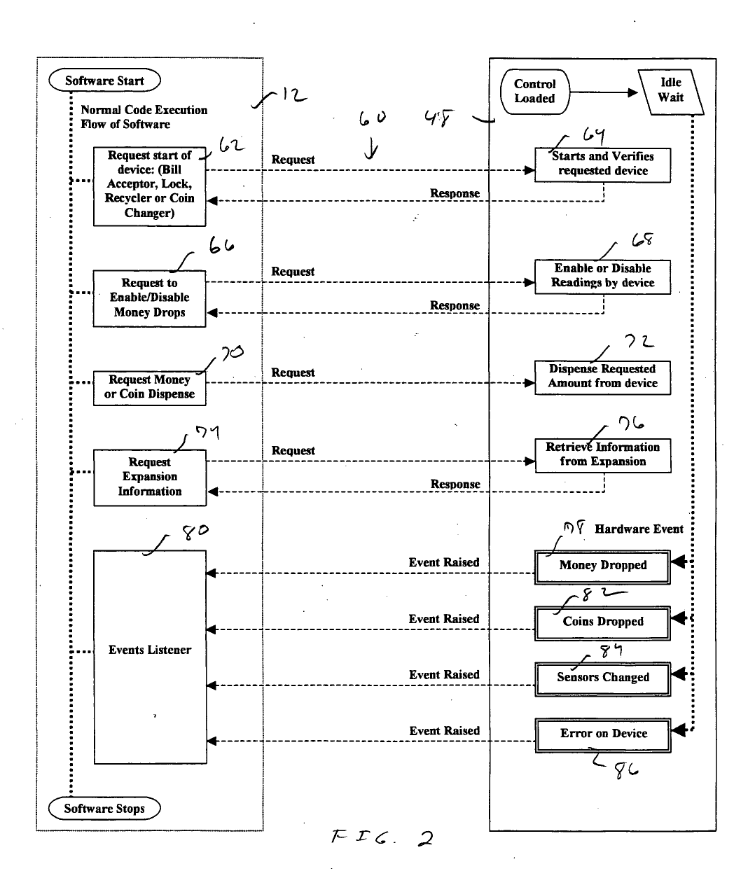

Referring to FIG. 2, a flow diagram illustrates operation of the POS system 12 and hardware control module 48 via the communication link 60. As is apparent, the POS system 12 implements numerous routines or programs for its general operation. As part of its general operation various commands are provided for interfacing with the cash dispensing system 10. Among these are the following. A request start of device block 62 sends a request to the hardware control module 48 which starts and verifies a requested device at a block 64. This routine can be used at start up to commence operation of, for example, the bill acceptor 50, the locks 32, the bill dispenser and acceptor 52 or the coin changer 44. A block 66 provides a request to enable or disable money drops which is transmitted to a block 68 which enables or disables readings by the device. This relates to operation of the tube vending box.

At the completion of a transaction, after a customer has paid, and it is necessary to provide change to the customer, then the POS system 12 at a block 70 sends a request that currency or coin be dispensed. The request is received at a block 72 which dispenses the requested amount from the appropriate device. Particularly, the hardware control module 48 will command operation of the coin change 44 to dispense coins or the bill dispenser and acceptor 52 to dispense paper currency.

A block 74 is implemented to send a request for expansion information to a block 76 which retrieves information from the expansion boards 42. This is used to monitor the status of the tube vending box 38.

Hardware events are sensed by the hardware control module 48 as follows. A block 78 senses if money has been dropped in either the bill acceptor 50 or bill dispenser and acceptor 52 and then transmits such information to an events listener block 80 of the POS system 12. A block 82 monitors and determines if coins have been dropped in the coin changer 44 and transmits such information to the events listener block 80. A sensors changed block 84 determines if any door has been opened or closed and provides such information to the events listener block 80. A block 86 determines if any errors are sensed and provides such information to the events listener block 80. The events listener block 80 updates the POS system 12 to determine if appropriate payment has been made and if any change should be given, as described above.

As described, cash in the form of paper currency or coins is fed directly to the cash validation system 10 which then communicates the receipt of such information via the hardware control module 48 to the POS system 12. The POS system 12 then compares the money received to the money due. If any change is required, then the POS system 12, via the hardware control module 48, commands the cash validation system 10 to return the correct change to the customer. The entire transaction is captured and managed through the POS system 12. Moreover, as with the referenced application incorporated by reference herein, all activities of the safe 30 are monitored so that an audit trail of all transactions can be monitored to minimize internal shrinkage and theft.

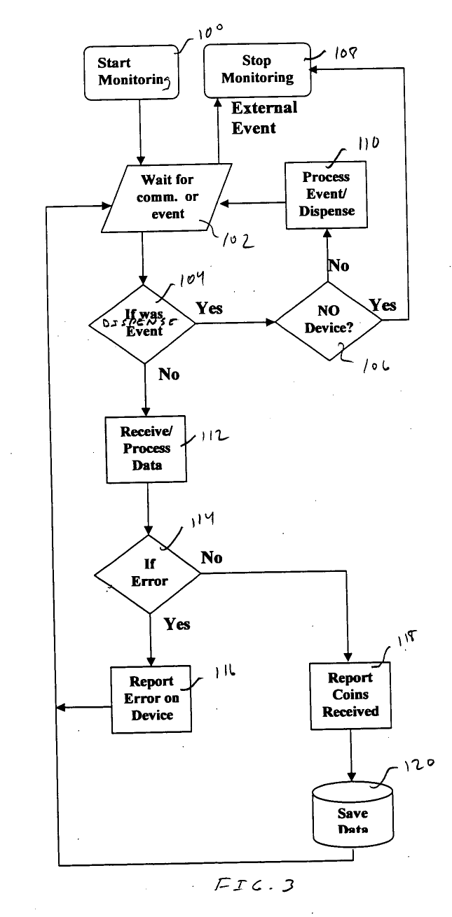

Referring to FIG. 3, a flow diagram illustrates a routine implemented in the hardware control module 48 for interface with the coin changer 44. The monitoring begins at a block 100 upon direct request to the hardware control module 48. The hardware control module 48 thereafter manages the interface operation. The routine waits at a block 102 until a request event is received from the POS system software or until state of the communication, i.e., serial, port has been changed indicating a hardware event. A decision block 104 determines if a dispense event is what triggered the control. If so, then a decision block 106 detects for the presence of the coin changer 44. If the coin changer 44 is not present, then the control stops monitoring at a block 108. If the coin changer 44 is present, then the event is processed by dispensing the coins at a block 110. The control then returns to the block 108 to await the next task.

Returning to the decision block 104, if a change in state of the serial port is detected, then control proceeds to a block 112 to receive and process data from the coin changer 44. This information tells how many coins of each denomination have been dropped into the coin changer 44 and if any tube is full. A decision block 114 determines if an error has occurred when receiving or processing the information. If so, then the control reports an error at a block 116 and returns to the block 102. If no error has occurred, then the control reports the coins received at a block 118 to the POS system software. The control then saves the information about the coins that are in the device as indicated at 120 and returns to the waiting state at the block 102.

The monitoring can be stopped by request of the software or through an external request to the hardware control module 48. The control will then stop monitoring the next time it enters a waiting state by proceeding to the block 108, as indicated.

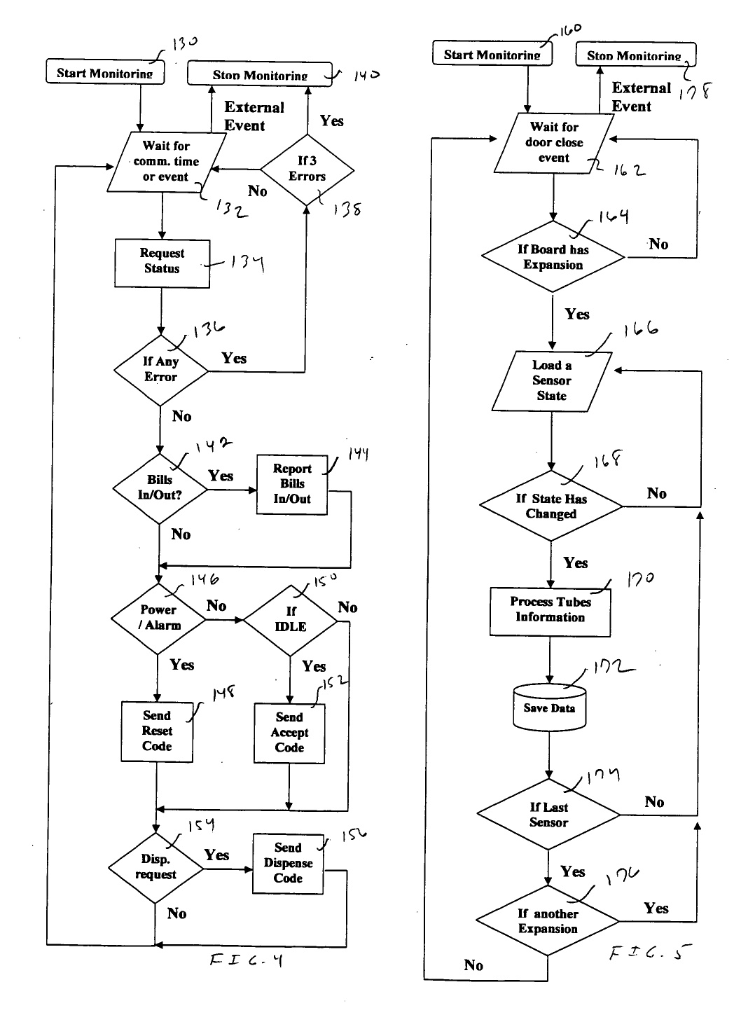

Referring to FIG. 4, a flow diagram illustrates operation of the hardware control module 48 for interface with the bill dispenser and acceptor 52. As is apparent, interface with the bill acceptor 50 is generally similar ignoring any dispensing requests.

Monitoring begins at a block 130 upon direct request to the hardware control module 48. Interface is then managed solely by the hardware control module 48. The control waits at a block 132 and communicates with the bill dispenser and acceptor 52 at regular intervals to receive device status at a block 134. This status determines if the device is working properly and if any bills have been inserted or removed. If an error has occurred while trying to receive status, at a decision block 136, then a decision block 138 determines if there have been three errors. If not, the control returns to the waiting state until it is time to try again. If there have been three errors, then the control stops monitoring at a block 140.

If there has not been any error as determined at the decision block 136, then a decision block 142 determines if bills have been inserted or removed. If so, then the control reports this occurrence at a block 144. A decision block 146 determines if the status reports a recent power on or alarmed state. If so, then a reset code is sent at a block 148 to force a hardware check done by the device itself. If not, then a decision block 150 determines if the status reports an idle state. If so, then an acceptance code is sent at a block 152 enabling bill readings using the device. If not in the idle state, or from any of the blocks 148 or 152, a decision 154 determines if a bill dispense was previously requested to the control. If so, then the appropriate dispense code is sent at a block 56 to the bill dispenser and acceptor 52.

After checking and/or performing a bill dispense request, the control returns to a waiting state at the block 132 until it is time to perform any of the indicated procedures. The monitoring can be stopped by request of the software through an external request to the control which then proceeds to the block 140. The control will then stop the monitoring the next time it enters a wait state.

Referring to FIG. 5, a flow diagram illustrates a routine implemented by the hardware control module 48 for tube vending. Monitoring starts at a block 160 along with normal safe monitoring. A block 162 waits for a door close event. At this time, the software communicates with the board and verifies the existence of a tube vending expansion board 42. A decision block 164 determines if there is an expansion board. If no expansion board is found, then the control resumes monitoring by returning to the block 162. If the expansion board exists, then the software reads the state of the sensors 40 at a block 166 and determines at a block 168 if anything has been loaded or withdrawn. If nothing has been done, then it returns to the block 166 to verify the next set of sensors. If the state of any of the sensors have changed, then a block 170 processes all of the information relating to withdrawal or loading of tubes. Once the information is processed, then it is stored in the database at a block 172 for later auditing and for processing of alerts. A decision block 174 determines if the last sensor has been read. If there are more sensors, then the sequence is restarted by loading the next sensor at the block 166. If the last sensor has been read, then a decision block 176 determines if there is a second expansion board. If so, then control returns to the block 166 to load and process sensors from the second board. If no other expansion board exists, then the control returns to the wait state at the block 162.

An external event can stop the monitoring of the door at the same time that it stops the monitoring of the safe by proceeding to a block 178.

Thus, there is described a cash validation system 10 for use with a point of sale system 12 to provide a self service checkout system 14. The cash validation system 10 includes a safe 30 having a door lock 32 and door sensors 34. A bill dispenser and acceptor 52 is mounted on the safe for receiving and dispensing paper currency. A coin changer 44 is mounted on the safe 30 for receiving and dispensing coins. The control unit 36 is operatively coupled to the bill dispenser and acceptor 52 and the coin changer 44 for monitoring commanding operation of the bill acceptor and dispenser and the coin changer. The hardware control module 48 provides an interface between the control unit 36 and the POS system 12 for communicating information on received paper currency and coins to the POS system 12 and receiving requests from the POS system 12 to dispense change and in response to the request commanding operation of the bill dispenser and acceptor 52 and the coin changer 44.

I claim:

1. A cash validation system for use with a point of sale system to provide a self service checkout system, comprising:
a bill acceptor for receiving paper currency;
a coin changer for receiving and dispensing coins;
a control unit operatively coupled to the bill acceptor and the coin changer for monitoring and commanding operation of the bill acceptor and the coin changer; and
an interface operatively coupled between the control unit and the point of sale system for communicating information on received paper currency and coins to the point of sale system and receiving requests from the point of sale system to dispense change and in response to said requests commanding operation of the coin changer.

2. The cash validation system of claim 1 wherein the point of sale system comprises a programmed processing system and the interface comprises a hardware control module implemented in the programmed processing system.

3. The cash validation system of claim 2 wherein the control unit is connected to the programmed processing system via a communication link.

4. The cash validation system of claim 3 wherein the communication link comprises a serial interface.

5. The cash validation system of claim 2 wherein the hardware control module comprises a coin changer interface routine for monitoring communications from the coin changer to receive device information and monitoring dispense events from the programmed processing system and in response to dispense events commanding operation of the coin changer.

6. The cash validation system of claim 2 wherein the hardware control module comprises a bill acceptor interface routine for monitoring communications from the bill acceptor to receive device information.

7. A cash validation system for use with a point of sale system to provide a self service checkout system, comprising:
a bill dispenser and acceptor for receiving and dispensing paper currency;
a coin changer for receiving and dispensing coins;
a control unit operatively coupled to the bill acceptor and dispenser and the coin changer for monitoring and commanding operation of the bill acceptor and dispenser and the coin changer; and
an interface operatively coupled between the control unit and the point of sale system for communicating information on received paper currency and coins to the point of sale system and receiving requests from the point of sale system to dispense change and in response to said requests commanding operation of the bill acceptor and dispenser and the coin changer.

8. The cash validation system of claim 7 wherein the point of sale system comprises a programmed processing system and the interface comprises a hardware control module implemented in the programmed processing system.

9. The cash validation system of claim 8 wherein the control unit is connected to the programmed processing system via a communication link.

10. The cash validation system of claim 9 wherein the communication link comprises a serial interface.

11. The cash validation system of claim 8 wherein the hardware control module comprises a coin changer interface routine for monitoring communications from the coin changer to receive device information and monitoring dispense events from the programmed processing system and in response to dispense events commanding operation of the coin changer.

12. The cash validation system of claim 8 wherein the hardware control module comprises a bill acceptor and dispenser interface routine for monitoring communications from the bill acceptor and dispenser to receive device information and monitoring dispense events from the programmed processing system and in response to dispense events commanding operation of the bill acceptor and dispenser.

13. The cash validation system of claim 7 further comprising a safe housing the bill dispenser and acceptor, the coin change, and the control unit.

14. The cash validation system of claim 13 wherein the safe comprises door locks and door sensors and the interface communicates information on sensed door status to the point of sale system and receives device requests from the point of sale system to operate the door lock and in response to said device requests commanding operation of the door lock.

15. The cash validation system of claim 13 wherein the safe comprises a tube vending device and the interface communicates information on sensed tubes to the point of sale system.

16. A cash validation system for use with a point of sale system to provide a self service checkout system, comprising:
a safe having a door lock and door sensors;
a bill dispenser and acceptor mounted on the safe for receiving and dispensing paper currency;
a coin changer mounted on the safe for receiving and dispensing coins;
a control unit operatively coupled to the bill acceptor and dispenser and the coin changer for monitoring and commanding operation of the bill acceptor and dispenser and the coin changer; and
an interface operatively coupled between the control unit and the point of sale system for communicating information on received paper currency and coins to the point of sale system and receiving requests from the point of sale system to dispense change and in response to said requests commanding operation of the bill acceptor and dispenser and the coin changer.

17. The cash validation system of claim 16 wherein the point of sale system comprises a programmed processing system and the interface comprises a hardware control module implemented in the programmed processing system.

18. The cash validation system of claim 17 wherein the hardware control module comprises a coin changer interface routine for monitoring communications from the coin changer to receive device information and monitoring dispense events from the programmed processing system and in response to dispense events commanding operation of the coin changer.

19. The cash validation system of claim 17 wherein the hardware control module comprises a bill acceptor and dispenser interface routine for monitoring communications from the bill acceptor and dispenser to receive device information and monitoring dispense events from the programmed processing system and in response to dispense events commanding operation of the bill acceptor and dispenser.

20. The cash validation system of claim 17 wherein the interface communicates information on sensed door status to the point of sale system and receives device requests from the point of sale system to operate the door lock and in response to said device requests commanding operation of the door lock.

21. The cash validation system of claim 17 wherein the safe comprises a tube vending device and the interface communicates information on sensed tubes to the point of sale system.
